(19) United States
(12) Patent Application Publication
(10) Pub. No.: US 2017/0316470 A1
(43) Pub. Date: Nov. 2, 2017

(54) Consultant Booking and Tracking System

(71) Applicant: InApp Inc., Lloyd Harbor, NY (US)

(72) Inventors: Jamie Proctor, Huntington, NY (US); Jeffrey Leventhal, Lloyd Harbor, NY (US)

(21) Appl. No.: 15/497,415

(22) Filed: Apr. 26, 2017

Related U.S. Application Data
(60) Provisional application No. 62/328,134, filed on Apr. 27, 2016.

(51) Int. Cl. G06Q 30/02

(52) U.S. Cl. CPC G06Q 30/0281; G06Q 30/0284

(57) ABSTRACT

Methods, systems, and apparatus, including computer programs encoded on computer storage media for a consultant booking and tracking system. One of the method includes providing a code insert configured to integrate with an application and connect to a remote service, separate from the application to enable remote service, separate from the application to enable the selling and delivering of professional services, consulting, training and technical support and enable a user to request a session with a consultant for the application from within the application. The code insert is configured to connect the user to the consultant. The code insert is configured to track the duration of the session. The method also includes charging the user for the session based on the duration.

### CLAIM OF PRIORITY

This application claims priority to U.S. Patent Application Ser. No. 62/328,134, filed on Apr. 27, 2016, the entire contents of which are hereby incorporated by reference.

### BACKGROUND

A consultant is a professional who provides professional or expert services in a particular area such as security, management, education, accountancy, law, human resources, marketing, finance, engineering, science or any of many other specialized fields. External consultants are individuals whose expertise is provided on a temporary basis, usually for a fee. As such, this type of consultant generally engages with multiple and changing clients. Internal consultants are individuals who work for companies whose expertise is provided on a permanent basis.

### SUMMARY

In general, one innovative aspect of the subject matter described in this specification can be embodied in methods that include the actions of providing a code insert configured to integrate with an application or web page and connect to a remote service, separate from the application to: remote service, separate from the application to enable the selling and delivering of professional services, consulting, training and technical support and enable a user to request a session with a consultant for the application from within the application. The code insert is configured to match the user to the consultant. The code insert is configured to track the duration of the session. The method also includes the actions of charging the user for the session based on the duration.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The methods may include the actions of receiving the request for the session and identifying a consultant based in part on the application and a requested time. The requested time may be the current time. The consultant may be identified from a pool of available consultants that have been approved to provide services for the application. The consultants may be added to the pool of available consultants based on the consultant indicating their availability and skills. Connecting the user to the consultant may include establishing a network connection or API between the user and the consultant, the network connection configured to enable audio/video communication. The application may be hosted by a software partner and accessed by the user using a thin client. The code insert may be provided using a scripting language capable of being executing using a web browser.

### BRIEF DESCRIPTION OF THE DRAWINGS

FIG. 1 illustrates an environment that connects subscribers to consultant help from within a SaaS application.

FIG. 2 illustrates an example of integrating a third party consultant system with a SaaS application.

FIG. 3 illustrates an example of a series of user interface inserts that can be used to schedule an appointment with a consultant.

FIG. 4 illustrates an example of interfaces for signing up a new user.

FIG. 5 illustrates an example consultant session with a user.

FIG. 6 illustrates a chat interface from the consultants system.

FIG. 7 illustrates an example architecture for an integrated consultant system.

FIG. 8 illustrates an example of a web interface for a software partner.

FIG. 9 illustrates an example of web interface for a user.

FIG. 10 illustrates an example of a web interface for a consultant.

FIG. 11 illustrates an example of a web interface for a consultant.

FIG. 12 illustrates another web interface for a consultant.

FIG. 13 illustrates an example of a consultant's schedule.

FIG. 14 illustrates an example of a consultant's appointments presented in a list.

FIG. 15 illustrates an example of an appointment presented to a consultant.

FIG. 16 illustrates an example of a user interface for summarizing an engagement.

FIG. 17 illustrates an example of a user interface for creating a service catalog.

FIG. 18 illustrates an example of a user interface for creating a product offering in a service catalog.

FIG. 19 illustrates an example of a user interface for displaying a product offering to a user.

FIG. 20 is a flowchart of an example of a process for embedding service offerings into an application.

Like reference numbers and designations in the various drawings indicate like elements.

### DETAILED DESCRIPTION

Users of software systems frequently need expert service and help with preforming certain tasks. An embedded control can enable the user to contact, schedule, and meet with an expert from within the software environment.

One common model of providing software is commonly referred to as software as a service (SaaS) is a software licensing and delivery model in which software is licensed on a subscription basis. The software can be centrally hosted and accessed using a thin client such as a web browser. SaaS is typically accessed by users in this way. SaaS has become a common delivery model for many business applications, including office and messaging software, payroll processing software, DBMS software, management software, CAD software, development software, accounting, collaboration, customer relationship management (CRM), management information systems (MIS), enterprise resource planning (ERP), invoicing, human resource management (HRM), talent acquisition, content management (CM), antivirus software, and service desk management.

A system can be used to connect users of software applications (including subscribers of a SaaS systems) with employees of the software partner, employees of a consultancy, independent contractors, and other consultants (collectively referred to herein, generally, as consultants) that can assist the user in the development and use of the software packages.

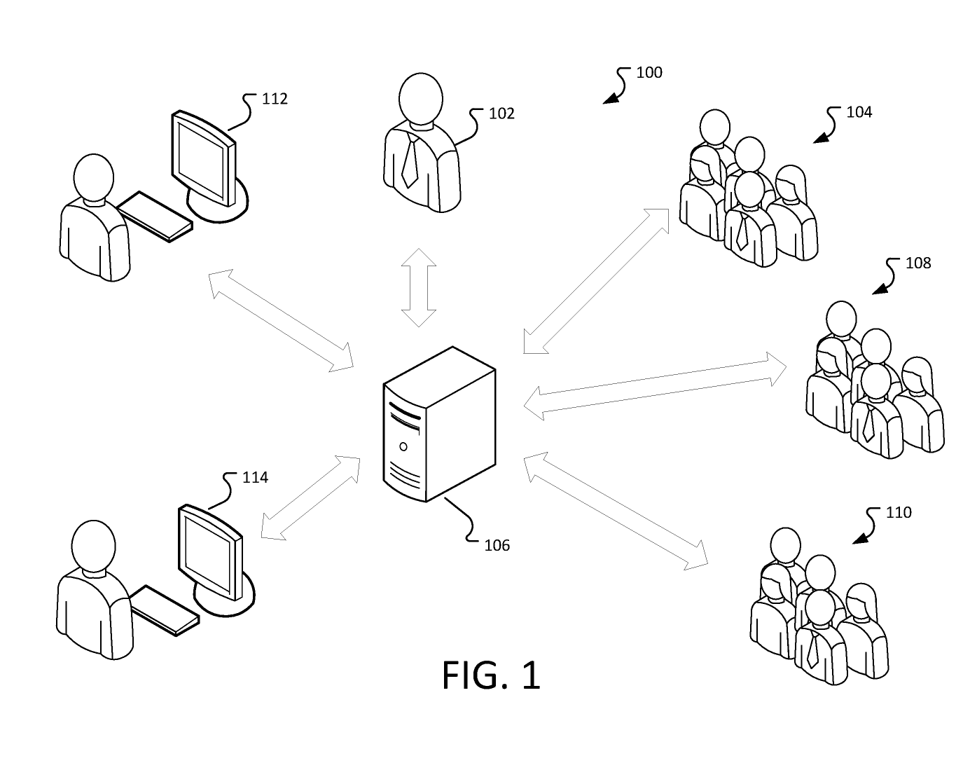

FIG. 1 illustrates an environment 100 that connects subscribers to consultant help from within a software application. A manager 102 of application can establish a talent pool (or group) of consultants 104 with a system 106 (for example, a talent pool of people who are knowledgeable about the particular software application managed). The manager 102 can assign or invite one or more consultants to the talent pool. In some implementations, the manager 102 can establish multiple talent pools of consultants. For example, one talent pool of consultants can be knowledgeable about one aspect of the software application and another talent pool of consultants can be knowledgeable about another aspect of the software application. A consultant can be part of one or more different talent pools.

The system 106 can maintain a list of talent pools of consultants 104, 108, 110. Each talent pool of consultants can be knowledgeable about a different application or different portion(s) of an application.

Users 112, 114 of software applications can request help with a particular problem. The request can be made from within the software application and sent to the system 106. The system can identify available consultants from the appropriate talent pool of consultants and either connect the user with the consultant (if available) or schedule a future meeting with the consultant.

When a user (for example, user 114) meets with a consultant, the system 106 can track the amount of time, milestones, and/or expenses the user spends with the consultant and bill the user accordingly.

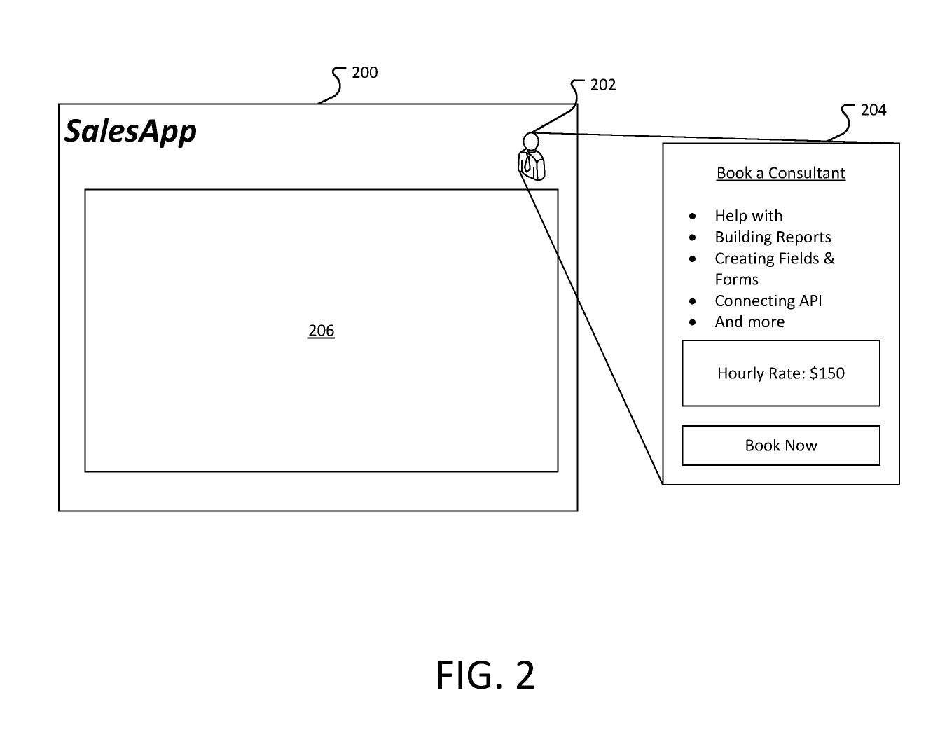

FIG. 2 illustrates an example of integrating a third party consultant system with a software application. A user interface 200 of a software application can include an area 206 that presents the substantial content of the software application and an icon 202 associated with requesting consultant assistance from a server. The icon 202 can be an insert added into the user interface 200 of the software application. For example, the icon 202 can be part of a JavaScript insert. The insert can be generated by the system 106 and inserted by the Manager of the SaaS application 102. It is further contemplated that the insert can also be placed onto a web page. It is further contemplated that the insert can be embedded as a plugin into a Web Browser. The insert can be provided by the server, as discussed further below.

In the event that the user of the software application selects the icon 202, a user interface 202 can cause an offer for consultant services 202 to be presented to the user. The offer 204 can be presented in a pop-up window or in line with the user interface 200; for example, the user interface 200 can expand to allow the offer 204 to be presented.

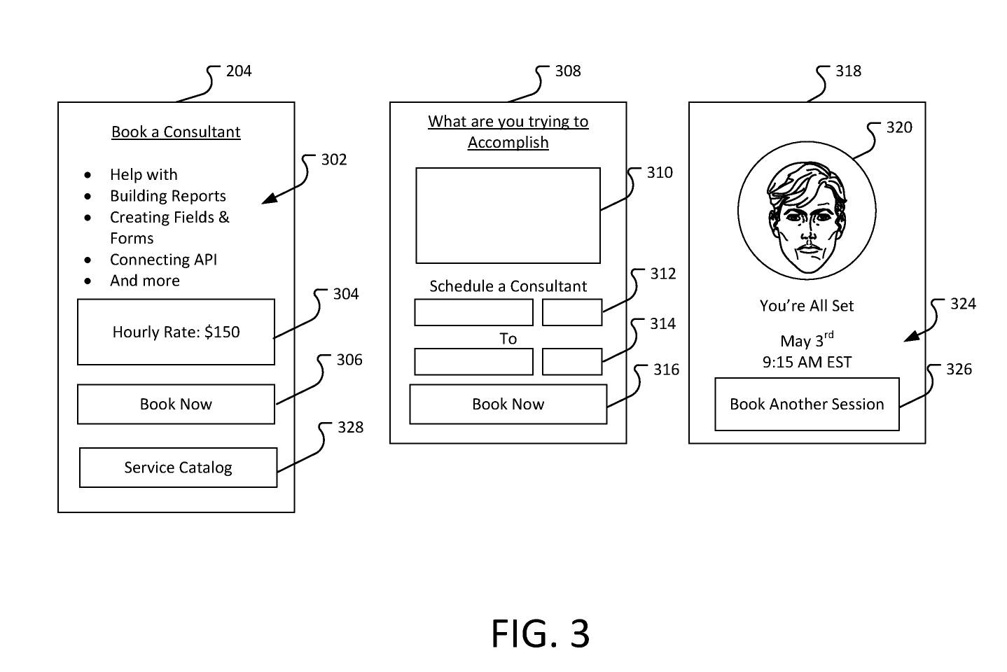

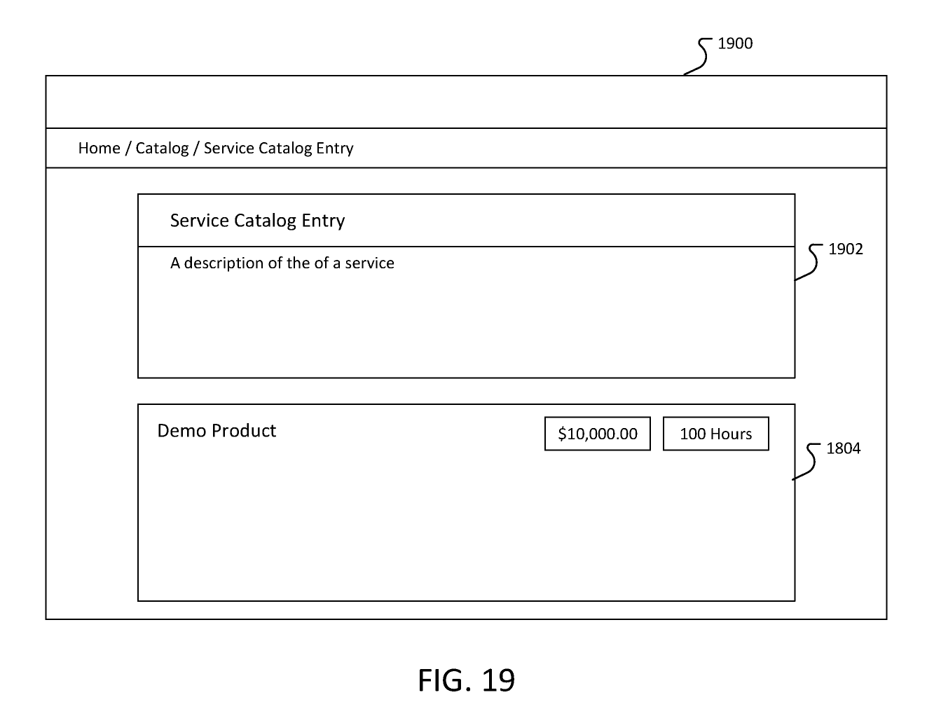

FIG. 3 illustrates an example of a series of user interface inserts that can be used to schedule an appointment with a consultant. The first user interface of the inserts can be the offer 204 as described above with respect to FIG. 2. The offer 204 can include a list 302 of different issues for which the consultants can be qualified to help. The offer 204 can also include an hourly rate 304 for the consultants' help. The offer 204 can also include a “book now” button 306 that navigates the system to the next screen. In some implementations, the offer 204 can include a service catalog button 328 that navigates the user to a service catalog, as discussed further below with respect to FIG. 19.

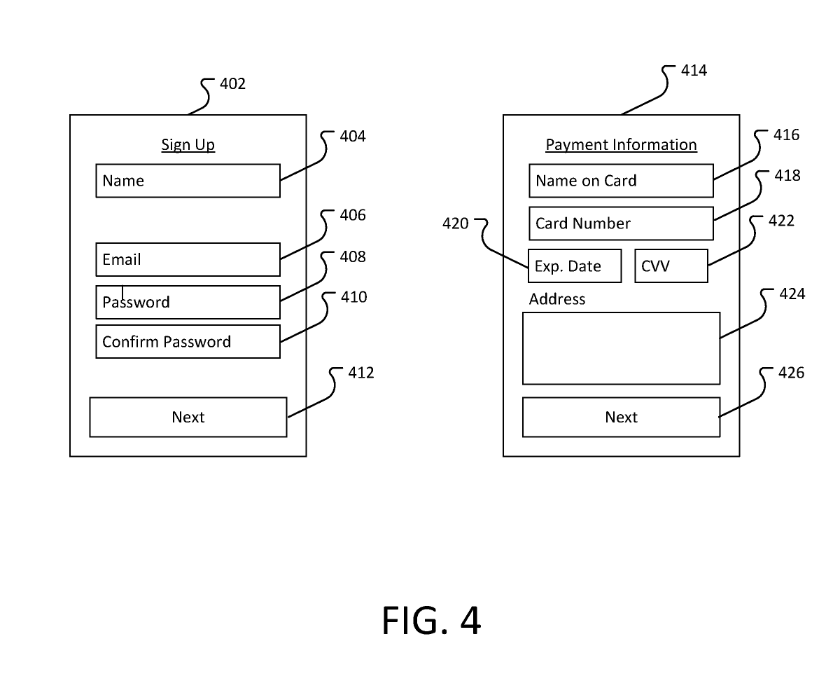

When the user navigates away from the offer 204 to either a system catalog or the booking interface 308, the system can check if the user already has an account with the system. If the user does not have an account, the user can be presented with a sign up screen, as described below with respect to FIG. 4. If the user already has an account, the user can be presented with a booking interface 308.

The booking interface 308 allows the user to book a consultant session. In a text area 310, the user can provide details about the problem that the user is attempting to solve. The user can also schedule the start date and time 312 and the end date and time 314 for the consultant session. In some implementations, the user can select a range of times that would be acceptable for a consultant session. Alternatively, or additionally, the user can request an immediate consultant session. The booking interface 308 can include a button that navigates to the confirmation interface 318.

The confirmation interface 318 can provide a confirmation that the appointment has been established. The confirmation screen can include a picture of the user looking to book a consultant. The confirmation interface 318 can also include the scheduled date and time 324 of the consultant session. The confirmation interface 318 can enable the user to book another consultant, which would then present the booking interface 308 a second time.

FIG. 4 illustrates an example of the new user sign up. A sign up screen 402 includes a location for a user to specify their name 402, e-mail address 406, password 408, and a password confirmation 410. In some implementations, the sign up screen 402 can allow a user to provide a profile picture; for example, the user can select a profile picture or the user can take a new picture using, for example, a camera on a personal computer. The system can also enable to user to verify the functionality of a microphone and video camera. In some implementations, new users can be required to confirm their e-mail address prior to gaining access to the system. Once the user provides the requested information, the user can navigate using the next button 412 to a payment screen 414.

In some implementations, new users can be required to confirm their e-mail address prior to gaining access to the system. For example, an activation code can be sent to the e-mail address of the user. A user can also specify their region and language.

The payment screen 414 enables the user to specify payment information that is stored to pay for later sessions. In this example, the payment screen 414 includes the ability to enter credit card information including the name on the card 416, the card number 418, the expiration date of the card 420, the CVV for the card 422, and address associated with the card 424. When the user selects the next button 416, they will be sent to the booking screen, as described above with respect to FIG. 3.

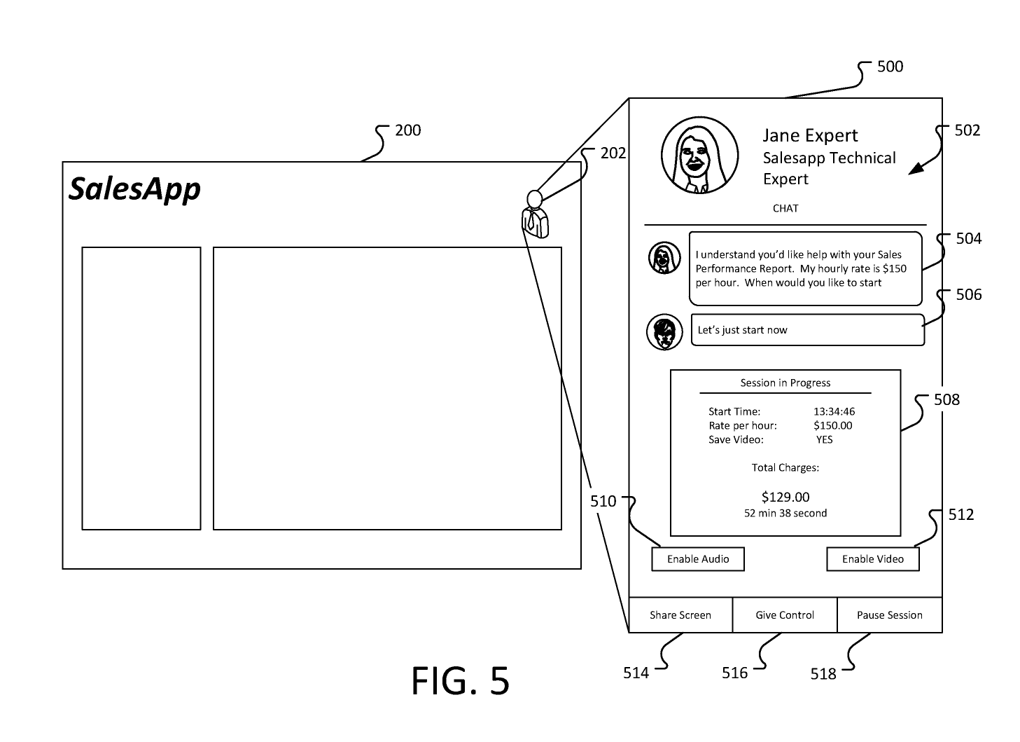

FIG. 5 illustrates an example consultant session with a user. At a scheduled time, the user can receive a notification that a consultant session is available to begin. For example, the user can have received a calendar invitation, or can receive a notification through the insert on the user interface.

The user can select the icon 202 or a link either in a calendar appointment, an e-mail, or presented on the user interface 200.

When the user elects to start the session, a chat interface 500 can be presented to the user. The chat can identify the technical consultant with whom the user is chatting 502. In this example, the user is chatting with Jane Consultant. The user and the consultant can communicate using text messages, voice, video, web chat or other method of communication (for example, messages 504 and 506).

In some implementations, the session starts when the user and the consultant agree to start the session. For example, the consultant can ensure that the user understands the cost of the services prior to engaging in the session. Once a session starts, a session summary 508 can be displayed in the chat interface. The session summary can include information such as the starting time of the session, the rate per hour for the session, whether audio and/or video of the session is being saved, the total charges incurred for the session so far, and the elapsed time for the session.

The user and the consultant can also communicate using audio communication (speech) (for example, by selecting the enable audio button 510). The user and the consultant can also communicate using video conferencing (for example, by selecting the enable video button 512).

The user can also be able to present other information to the consultant; for example, the user can share their screen 514 with the consultant. In general, screen sharing refers to an application that enables the user to allow the consultant to view, and potentially interact, with the user interface of the user.

The user can give control of the computer 516 to the consultant, enabling the consultant to manipulate the user interface of the user directly. The user can resume control (and take control away from the consultant) at any time. The user can also be able to pause 518 or terminate (not shown) the session at any time.

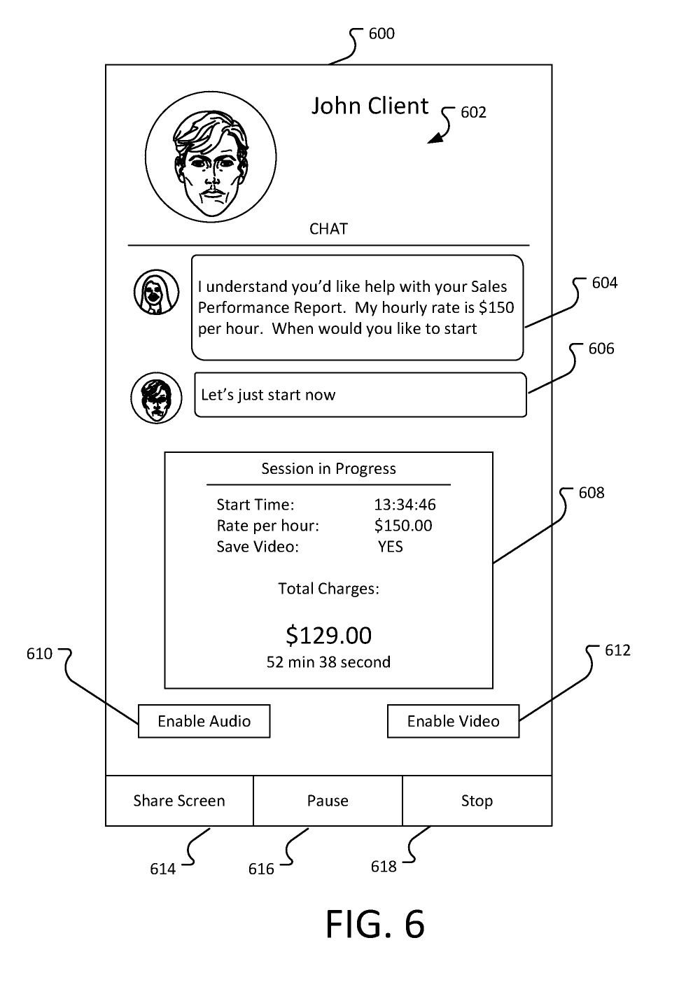

FIG. 6 illustrates a chat interface 600 from the consultant's system. Similar to the chat interface 500 described above, the chat interface 600 can identify the client 602 with whom the technical consultant is chatting. In this example, the consultant is chatting with John Client. The user and the consultant can communicate using text messages (for example, messages 604 and 606).

Once a session starts, a session summary 608 can be displayed in the chat interface. The session summary can include information such as the starting time of the session, the rate per hour for the session, whether audio and/or video of the session is being saved, the total charges incurred for the session so far, and the elapsed time for the session.

The user and the consultant can also communicate using audio communication (speech) (for example, by selecting the enable audio button 610). The user and the consultant can also communicate using video conferencing (for example, by selecting the enable video button 612.)

In some implementations, however, the consultant can not have the ability to share a screen or give control to the user. In other implementations, the consultant can have the ability to share a screen (for example, for demonstration purposes). In some implementations, the chat interface of the consultant and the chat window of the client have the same functionality.

In this example, the chat interface 600 includes buttons to allow the consultant to share her screen 614, pause the session 616, or stop the session 618.

In some implementations, when the session is stopped, the chat communication between the user and the consultant can be terminated.

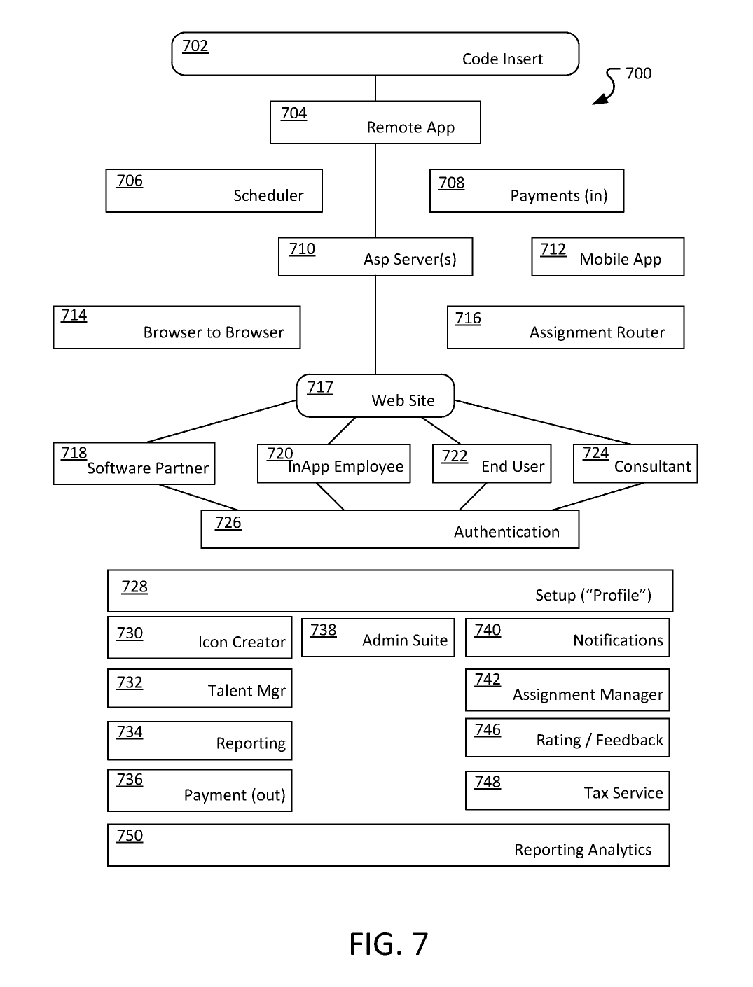

FIG. 7 illustrates an example architecture 700 for an integrated consultant system. The integrated consultant system can include a code insert 702. As discussed above, the code insert 702 can be, for example, JAVASCRIPT, HTML5, ACTIVESCRIPT, or another piece of software code that can be inserted into a software application. In some implementations, the code insert 702 can be customized by a manager of the software application.

The integrated consultant system can include a remote app 704. The remote app 704 can receive messages from the code insert 702. The remote App 704 can be displayed to a user as a result of placing the insert into the software application.

A scheduler 706 can match requests for meetings from users of the software application with application consultants who share availability at a particular time. Available consultants can be prioritized by the scheduler. For example, the scheduler can prioritize consultants based on ratings, skills, the amount of work previously completed, and other information available from a user profile for the consultant.

A payments (in) component 708 can accept payments from users. The payments (in) component 708 may, for example, integrate with a credit card processing system.

An app server 710 can receive requests from the remote app 704. The app server 710 can also integrate with a mobile app 712 (for example, being executed by a smart phone, tablet, or other mobile device).

The integrated consultant system can include a facility for the browser to browser communication component 714. For example, the integrated consultant system can use webRTC (an API definition drafted by the World Wide Web Consortium (W3C) that supports browser-to-browser applications for voice calling, video chat, and P2P file sharing without the need of either internal or external plugins). The browser-to-browser communications component 714 can include assessing management functionality; for example, the browser-2-browser communications component 714 can track the length of the session, provide the capability to record the session, and also can provide the capability of providing audio and/or video communications between the consultant and the user.

The aggregate consultant system can include an assignment router 716. The assignment router 716 can assign scheduled sessions to particular application consultants. In some implementations, the assignment router 716 can prioritize particular consultants based on criteria including, but not limited to, certifications, background checks, user reviews, historic availability, and other criteria. In scenarios in which the user requests an immediate session, the assignment router 716 can connect the user with a consultant that has indicated they are currently available, as discussed further below.

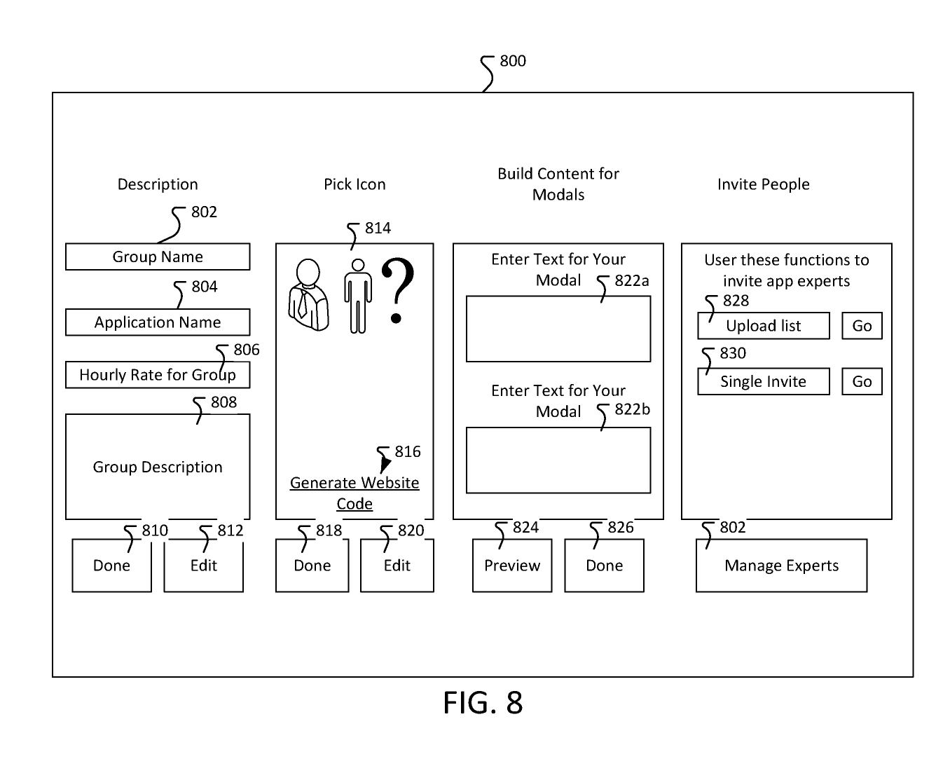

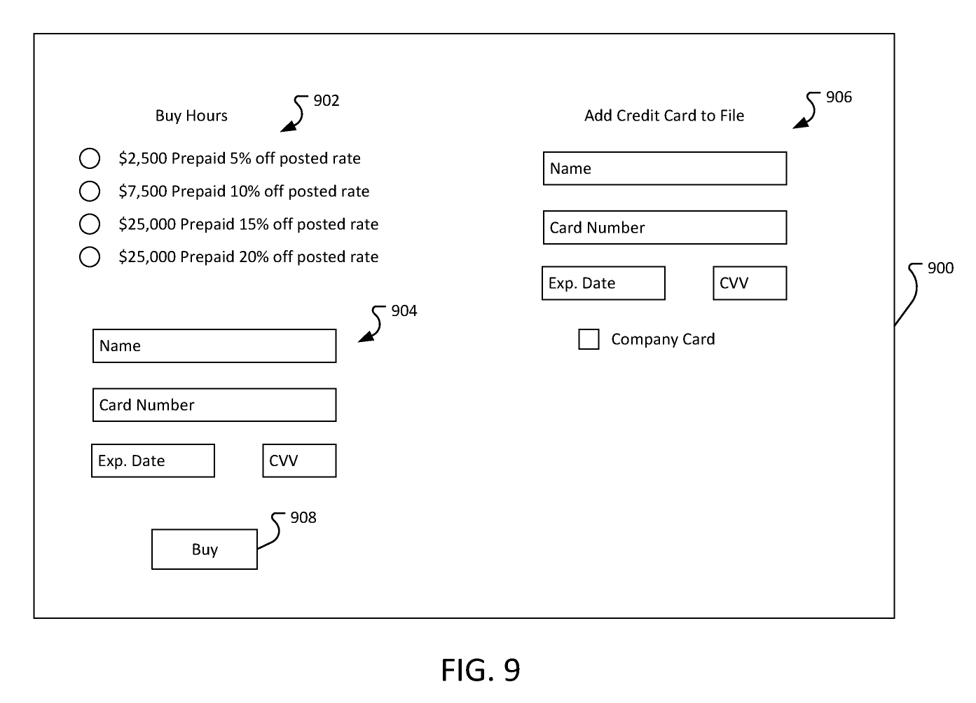

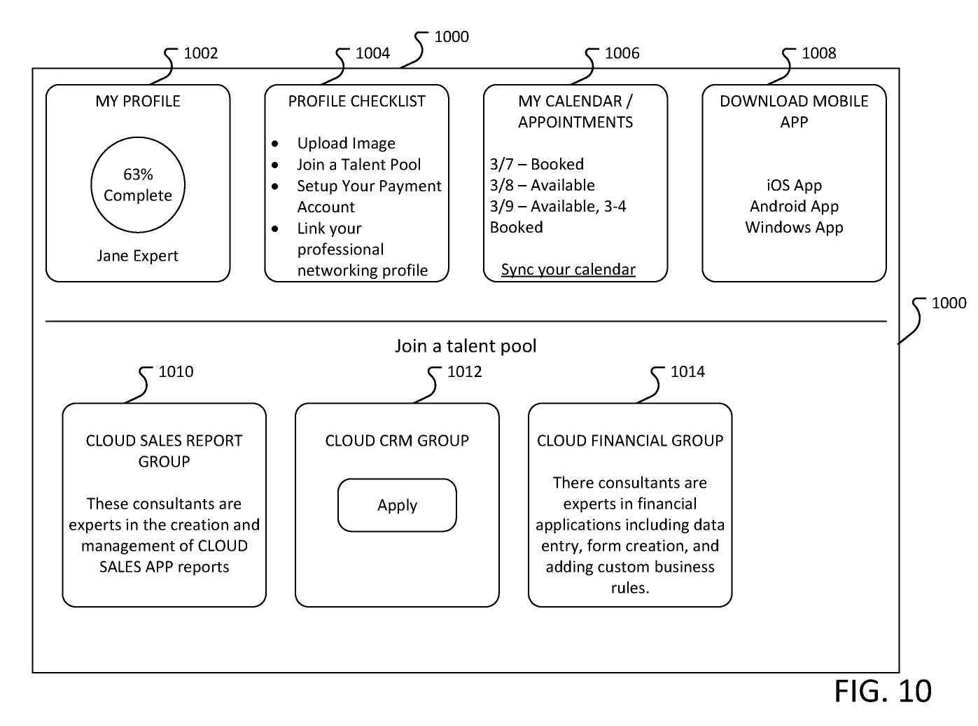

The aggregate consultant system can also include a web site 717 that enables users 722, consultants 724, software partners 718, and employees 720 to interact with the application. For example, a website for a software partner 718 is described below with respect to FIG. 8, a web site for a user 722 is discussed below with respect to FIG. 9, and a web site for a consultant is described below with respect to FIG. 10.

The aggregate consultant system can also include an authentication component 726. The authentication component can enforce authorization and authentication requirements (for example, login user name and password, biometrics, etc.) to verify that individuals accessing the web site are authorized to do so.

The aggregate consultant system can include the capability of setting up profiles 728 for software partners, users, and consultants. The profile can include payer/payee information, contact information, software applications in use, etc.

The aggregate consultant system can also include an icon creator 730. The icon creator can allow a software partner to select from among a set of available icons or to create an icon themselves. The icon can appear on the software application screen to enable a user to schedule an appointment or to receive immediate consultant assistance.

The aggregate consultant system can also include a talent manger 752. The talent manager enables a software partner to create talent pools of consultants, invite consultants into a talent pool, remove consultants from the talent pool, and delete talent pools.

The aggregate consultant system can also include a reporting system 734.

The aggregate consultant system can also include a payment (out) component 736. The payment (out) component 736 can enable payment to consultants, using, for example, direct deposit, check writing, online payment transfer (for example, using Pay Pal), etc.

The aggregate consultant system can also include an administrative suite 738 and reporting analytic 750.

The aggregate consultant system can include a notification component 740. The notification component can notify consultants of engagement and appointments.

The aggregate consultant system can include an assignment manager 742.

The assignment manager 742 can handle inbound and outbound routing of assignments as they are requested by the user.

The Assignment Manager can be designed to receive the type of job (application), timestamp & additional requirements and then based upon valid payment data is able to manage the expectations of the user. In some scenarios, consultants can be immediately available (consultants who are online and ready to jump on a session). The assignment manager can send notifications to the consultants in the appropriate talent pool alerting them of the new assignment.

The aggregate consultant system can include a rating/feedback component 746. The rating/feedback component can track and report user reviews for consultants. For example, after a session, the user can be given an opportunity to review the consultant. The review can include quantitative feedback (for example, a rating from 1 to 5 stars.). The review can also include qualitative feedback (for example, a written review).

The aggregate consultant system can include a tax service 748. The tax service can provide necessary tax documentations, for example US-1099 forms.

FIG. 8 illustrates an example of a web interface 800 for a software partner. The web interface 800 includes an area that enables the software partner to create talent pools of consultants. The software partner can specify a talent pool name 802, an application name 804, an hourly rate for the talent pool 806, and the description of the talent pool. Once the software partner has created the talent pool and is satisfied with details of the talent pool, the software partner can select the done button 810. The software partner also has the ability to edit existing talent pools by selecting the edit button 812 which can navigate the software partner to another screen.

The web interface 800 also includes an icon selection area 814. The software partner can select from a number of pre-generated icons or can create their own by selecting the edit button 820. The software partner can generate website code by activating the link 816. In some implementations, the software partner can customize the website code. Once the software partner is satisfied with the icon selection, the software partner can select the done button 818.

The web interface 800 also includes an area where the software partner can build content for modals. The web interface 800 can include multiple areas where the software partner can enter text for the modal 822a, 822b. The software partner can preview the modal by selecting the preview button 824. When the software partner is satisfied with the modal, the software partner can select the done button 826.

The web interface 800 also includes an area where the software partner can invite consultants to join a talent pool. The software partner can upload a list of consultants to invite using the text box 828. The software partner can also send single invitations to particular consultants using the text box 830. In some implementations, the system can track the status of consultants that have been invited to the talent pool. For example, the system can track the number of invitations that are outstanding and the amount of time each invitation has been outstanding. In some implementations, an invitation can only be valid for a finite period of time.

The web interface 800 also includes a manage consultants button 802 which enables the software partner to navigate to an additional screen to manage consultants that are already part of or invited to a talent pool.

FIG. 9 illustrates an example of web interface 900 for a user. The web interface 900 includes the ability for the end-user to pre-purchase hours 902. In some implementations, advance payments can result in a discount off of posted rates. In this example, if the end-user prepays $2500 they receive 5% off the posted rate.

In some implementations, users may purchase professional and consulting services using credits that they have previously purchased from their software partner or consultant. In some cases, a software partner or consultant may have sold professional service credits to their customers. In this case, a user has a “credit balance” that is maintained by the software partner of consultant that can be applied to the purchase of consulting or professional services through our system.

Our system will allow a connection between ourselves and the credit balance system at the software partner or consultant. Therefore, when a user looks to purchase services, they can either use a standard payment method (credit card, ACH, PAYPAL, etc. . . . ) or they may apply their credit balance to the purchase if they have one and the software partner or consultant has provided that information to our system. If they apply their credit balance, they will be able to understand their current balance, the amount of credits the service item costs, and once they make their purchase, can then see their new credit balance. Additionally, we will transmit the transaction details back to the consultant or software partner's credit system so the balances remain in sync.

The web interface 900 also includes an area 904 for the user to provide credit card information, including a name a card number and expiration date and a CVV. Once the user has entered the credit card information 904 the user can select the buy button 908.

The web interface 900 also includes the ability for the end-user to add a credit card to a file, using the credit card add area 906. The added credit card can be stored in the system and used for future purchases.

FIG. 10 illustrates an example of a web interface 1000 for a consultant. The web interface 1000 can include a profile section 1002 in which the consultant is encouraged to complete their profile. In this example, the consultant's profile is 63% complete. The consultant can be presented with a checklist 1004 of items that can do to complete the profile. These activities can include, but are not limited to, uploading an image or picture of the consultant, joining a talent pool, setting up a payment account, and linking to a professional network profile. In some implementations, the web interface 1000 can integrate with a camera coupled to the consultant's computer in order to take a photo. The user can set up a payment account using a variety of different payment methods, for example, the consultant can set up direct deposit into a checking account or online account (such as PAYPAL).

The web interface 1000 can include a summary 1006 of upcoming appointments and schedule events for the consultant. The web interface can include an option to synchronize an online calendar with the appointments listed in the summary 1006. The web interface 1000 can include an area 1008 that enables the user to directly link to download a mobile application for use with the consultant booking and tracking system.

The web interface can also include an area that enables the consultant to apply for and join a talent pool. Talent pools can be presented to the consultant, for example, the consultant can search for a talent pool using a search facility (not shown). The consultant can also have relevant talent pools presented to them. For example, the consultant can have been invited to one or more talent pools. Talent pools can be presented with a name and description of the talent pool, for example, as shown with boxes 1010 and 1014. The description can assist the consultant in determining whether or not to apply. The web interface can include a mechanism whereby the consultant can apply to join a talent pool. For example, as shown by box 1012, if the user hovers over a talent pool description, the user can be given an option to apply. Applications to a talent pool maybe routed to the talent pool owner (for example, a vendor partner).

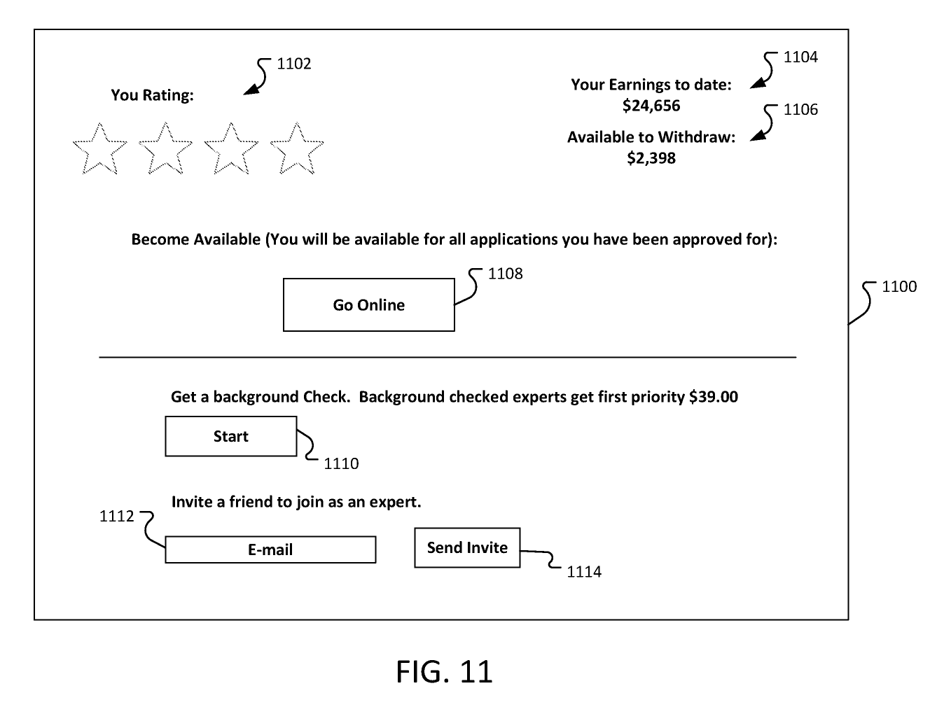

FIG. 11 illustrates an example of a web interface 1100 for a consultant. Once the consultant logs in, they can be presented with their rating 1102, the amount that they have earned to date 1104, and the amount that is available for withdrawal from the system 1106.

The consultant can select the go online button 1108 to notify the system that the consultant is available and ready to take calls or to attend a scheduled session.

The web interface 1100 can include offers and information available to the consultant. In this example, the consultant is offered the ability to have a background check run in order to increase their priority in the consultant queue. The consultant can select to accept the offer by clicking the start button 1110.

The web interface 1100 can also ask the consultant to recommend other consultants. The consultant can enter an email address in the text box 1112 and send an invite to the email address by selecting the send invite button 1114.

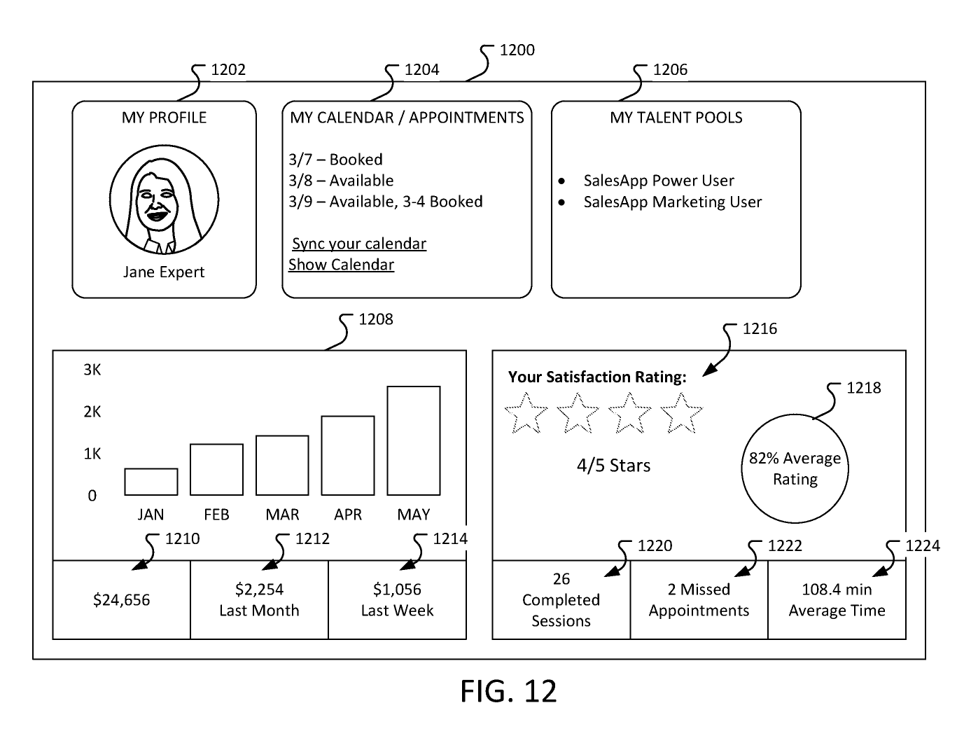

FIG. 12 illustrates another web interface 1200 for a consultant. The web interface 1200. Can include a profile area 1202. The profile area can enable a consultant to view and edit their profile.

The web interface 1200 can include a summary 1204 of upcoming appointments and schedule events for the consultant. The web interface can include an option to synchronize an online calendar with the appointments listed in the summary 1204. In some implementations, selecting the summary area 1204 can cause the web interface 1200 to navigate to a calendar application, as shown in more detail below.

The web interface 1200 can include a talent pool area 1206. The talent pool area 1206 can list the talent pools of which the consultant is a member. Selecting the talent pool can enable the consultant to search for and apply to talent pools.

The web interface 1200 can include an accounting area 1208 of the finances of the consultant. For example, the web interface 1200 can display the amount earned by the consultant over a time period 1210, the amount earned in the last month 1212, and the amount earned in the last week 1214. Selecting the accounting area 1208 can cause the web interface to navigate to a ledger which lists amounts earned by the consultant and amounts paid out to the consultant. In some implementations, the accounting area 1208 can include graphs and charts illustrating the earnings of the consultant over a period of time.

The web interface 1200 can include a performance/review rating of the consultant 1216. In some implementations, the rating can be broken down to provide additional information, for example, a numerical rating 1218, a number of completed sessions 1220, the number of appointments that the consultant has missed 1222, and the average amount of time spent per appointment 1224.

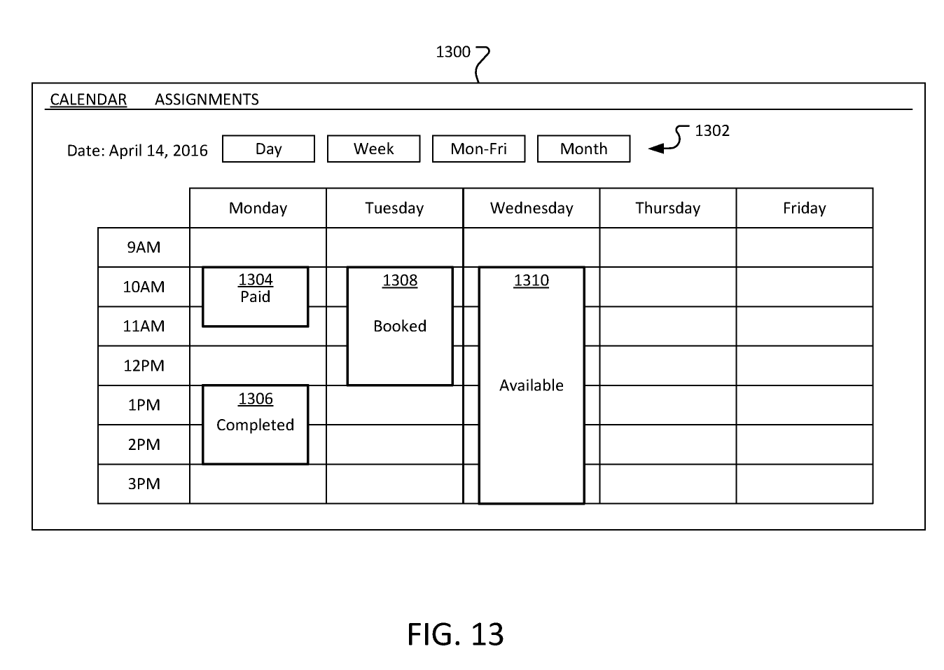

FIG. 13 illustrates an example of a consultant's schedule 1300. The schedule 1300 includes a calendar. The consultant can select if he wishes to view the calendar by the day, week, work week, or month 1302. Items on the calendar can be represented as paid 1304, indicating that the consultant has competed the work and been paid for the session. Items on the calendar has also represented as completed 1306 indicating that the consultant has completed the work, but has not yet been paid. Items on the calendar can be represented as booked 1308 indicating that the consultant has an appointment scheduled but not yet completed. Items on the calendar can also be represented as available 1310 indicating that the consultant is available for one or more sessions.

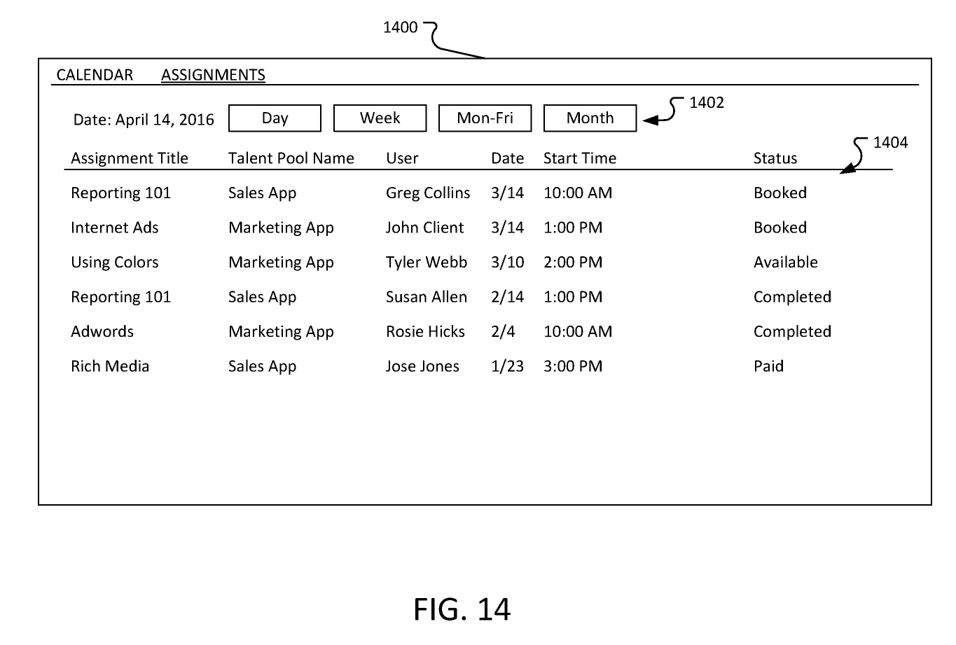

FIG. 14 illustrates an example of a consultants appointments 1400 presented in a list. The consultant can select if he wishes to view the appointments by the day, week, work week, or month 1402. The appointments can be presented in a list 1404. The appointment details can include an assignment title, the talent pool associated with the appointment, the user requesting the appointment, the date and time of the appointment, and the status of the appointment. In some implementations, selecting an appointment can provide additional details, for example, details provided by the user in the text area 310 of FIG. 3.

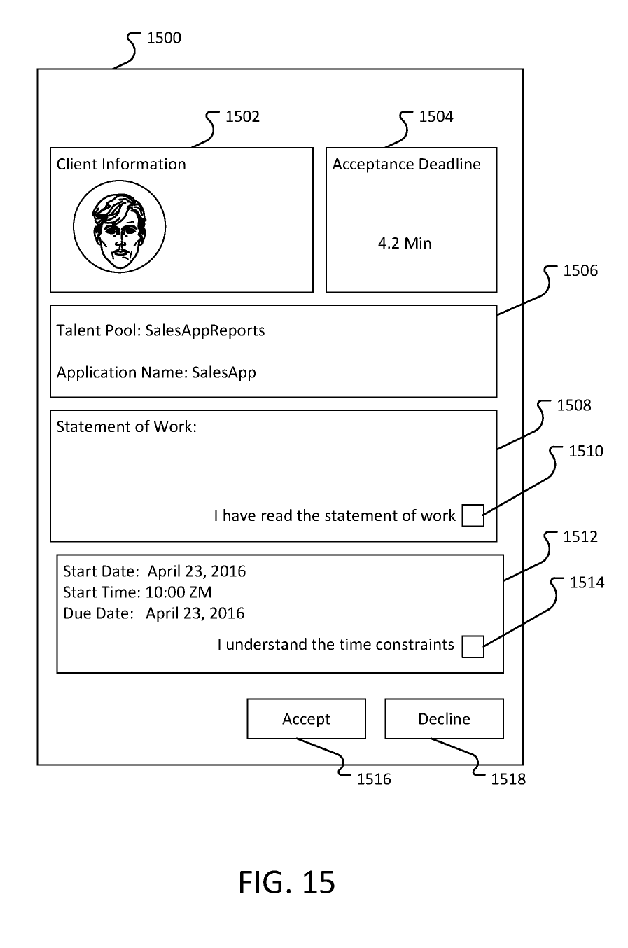

FIG. 15 illustrates an example of an appointment presented to a consultant. In this example, a user interface 1500, presents a pending appointment/contract to a consultant. The user interface includes client information 1502. The client information can include the client's name, address, and contact information. The user interface 1500 can include an acceptance deadline 1504 that indicates the amount of time the consultant has to accept the appointment before the appointment will be offered to another consultant. In this example, the consultant has 4.2 minutes remaining to accept the appointment. In some implementations, the consultant can be given a predetermined amount of time to accept an appointment, for example, 1 hour, 10 minutes, 5 minutes, etc. The consultant can be notified of a potential assignment, for example, using a push notification. If the consultant does not accept the assignment before the time expires, the assignment can be offered to another consultant.

The user interface 1500 informs the consultant about the talent pool and the name of the application to which the assignment pertains, for example, in the area 1506 of the user interface 1500.

The user interface 1500 includes a statement of work 1508. The statement of work can be defined by the client when the client requests the appointment/engagement or can be a standard statement of work provided by the system. In some implementations, a standard statement of work can be presented unless the client has specified a different statement of work.

The user interface 1500 includes a check box 1510 where the consultant indicates that she has read the statement of work 1508.

The user interface 1500 includes the time requirements of the appointment/engagement 1512. The user interface 1500 includes a check box 1514 where the consultant indicates that they understand the time constrains/appointment time.

The user interface 1500 provides the consultant with a button to accept 1516 the appointment/engagement or to decline 1518. If the consultant declines the appointment/engagement then the appointment/engagement can be offered to another consultant.

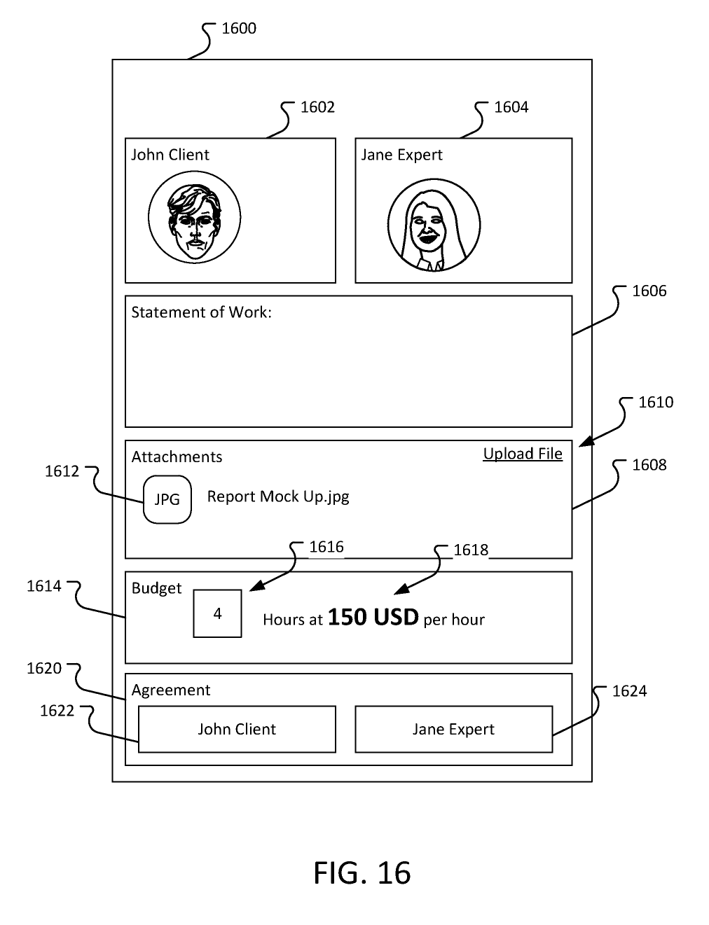

FIG. 16 illustrates an example of a user interface 1600 for summarizing and providing a shared workspace an engagement. The user interface 1600 identifies the client 1602 and the consultant 1604 who are parties to the engagement. The user interface 1600 can also display the statement of work 1606.

The user interface 1600 includes an area 1608 where either party can upload a file (for example, using the upload file link 1610). In this example, an image of a report mock up 1612 has been uploaded.

The user interface 1600 includes an area 1612 where a budget can be set. In this example, the user interface 1600 includes an editable text box 1616 where the number of hours can be set. The hourly rate of the consultant is predominantly displayed 1618.

The user interface 1600 can also include an area where the parties can agree to the budget. The agreement of a party can be indicated by clicking a button 1622 1624 that contains the party's name. In some implementations, once a party has agreed to the budget, the color of the button can change (for example, to green). Any change to the budget can cause the color of the button to revert back to a default color (for example, to grey).

The user interface 1600 can also include other information. For example, the user interface 1600 can include a record of any chat communication between the client and the consultant (not shown).

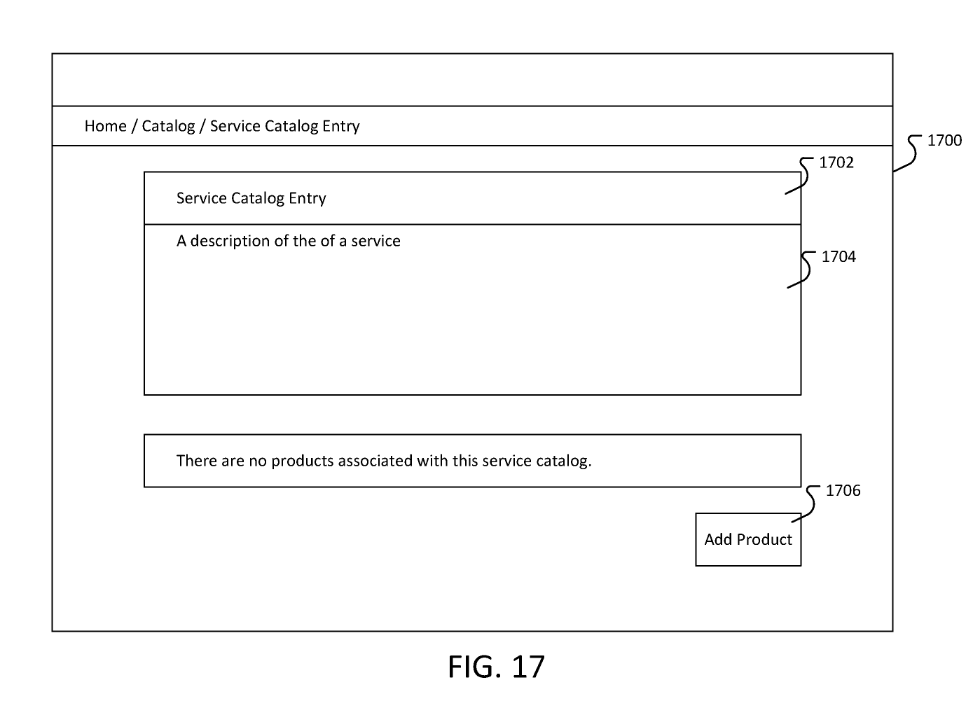

FIG. 17 illustrates an example of a user interface 1700 for creating a service catalog. The user interface can enable a consulting firm or organization to establish a service catalog in order to offer their goods and services. A service catalog, in general, can list different offerings for services. The user interface allows the user to specify a name for the service catalog and to provide a description of the kind of products and services that will be offered by the service catalog. Generally, a software partner can click a button to create a new catalog. Once they have created their catalog, they can add service related items (for example, by pressing the button 1706) to that catalog.

Individual products, service, or an entire catalog can be tied to a destination or “route”. The software partner may create these routes and destinations. This destination may be a talent cloud, an individual, or another destination for the supply of labor to complete the work associated with purchased products and/or services.

Once complete, this catalog can be linked to an embeddable and then displayed on the software partner's website or within their application. From there, a user of the application of software can browse and purchase service items from the catalog.

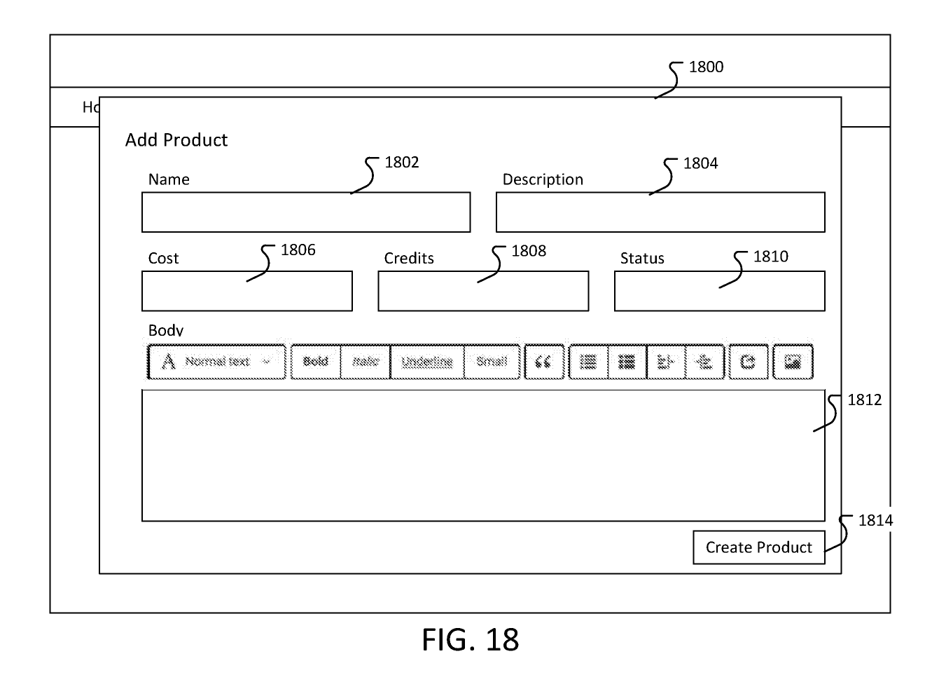

FIG. 18 illustrates an example of a user interface 1800 for creating a product offering in a service catalog. The user interface enables a user to define a new product/service offering. For example, the user can specify a name 1802 and provide a short description 1804 by populating the name field and the description field, respectively.

The user can also specify a cost 1806 for the product. The user can also specify the credits cost 1808 associated with a product. In some scenarios, a customer may have pre-purchased a number of credits. The product offering can include a cost in credits for the product/service.

The status 1810 field can be used by the user to indicate whether or not the product is currently available.

The user can provide additional information about the product offering in the body 1812 field of the user interface. While the description field is intended to be a short statement that can enable a potential buyer to easily identify the product, the body of the product can provide more nuanced and detailed information about the product. As such, the body field may be fully editable and can provide a wide variety of different formatting options (as illustrated by the format bar).

Once the user is satisfied with the product information, the user may select the “create product” button 1814 in order to add the new product to the service catalog.

In some implementations, the same or a similar user interface can be used to edit an existing product offering. In this circumstances, the text associated with the “Create Product” button may be altered to indicate that the user is saving edits to an existing product (as opposed to creating a new product).

FIG. 19 illustrates an example of a user interface 1900 for displaying a product offering to a user. When the user selects the service catalog button 328 from the offer 204 as shown in FIG. 3, the user can be directed to a service catalog interface. The service catalog interface can be, for example, a pop-up window that appears in front of the offer 204 or may replace the offer 204.

The user can see a service catalog entry 1902 that includes a name of the service catalog and a description of the types of services offered in the service catalog. The user can also see individual products that the user may purchase. In this example, the user can purchase a consulting package for $10,000 or for 100 credit hours of consulting.

In some implementations, the user can navigate back to the offer 204 by either selecting a button on the user interface or closing the user interface window.

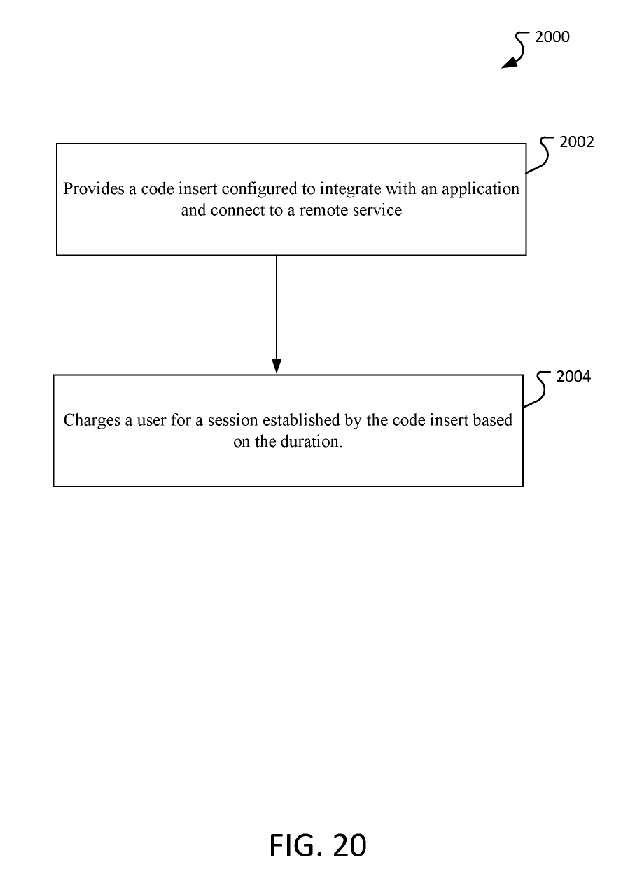

FIG. 20 is a flowchart of an example of a process 2000 for embedding service offerings into an application. The process may be performed by a computer system interacting with a client device and/or a user of the client device. In some implementations, one or more steps of the process may be performed by a computer processor executing instructions stored on a non-transitory computer storage medium. The instructions causing the computer processor to perform the steps.

The process 2000 provides 2002 a code insert configured to integrate with an application and connect to a remote service. The code insert can be, for example, code written in a scripting language (such as VB SCRIPT, JAVASCRIPT) and executable by a web browser or application installed on a client device.

The code inserted is configured to enable the selling and delivering of professional services, consulting, training and technical support for example, by enabling a user to request a session with a consultant for the application from within the application, connect the user to the consultant, and track the duration of the session.

The process 2000 charges the user for the session based on the duration.

In some scenarios, the process may receive receiving the request to start a session with a consultant, in response the process can identify a consultant based in part on the application and a requested time. For example, if the received request is for the current time the process identifies a consultant who is qualified and currently available. If the received request is for a future time, the process identifies a qualified consult who has indicated a willingness to accept contracts/calls for the future time.

Identifying a qualified consultant can include selecting a consultant from a pool of available consultants that have been approved by a software partner that provides the application.

The process 2000 can connect the qualified consultant with the requesting computer, this can include establishing a network connection for audio and/or video communication between the user and the consultant.

Embodiments of the subject matter and the functional operations described in this specification can be implemented in digital electronic circuitry, tangibly-embodied computer software or firmware, computer hardware (including the structures disclosed in this specification and their structural equivalents), or in combinations of one or more of them. Embodiments of the subject matter described in this specification can be implemented as one or more computer programs (i.e., one or more modules of computer program instructions encoded on a tangible non-transitory program carrier for execution by, or to control the operation of, data processing apparatus). The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example, a programmable processor, a computer, or multiple processors or computers. The apparatus can also be or further include special purpose logic circuitry (e.g., an FPGA (field programmable gate array) or an ASIC (application-specific integrated circuit)). In addition to hardware, the apparatus can optionally include code that creates an execution environment for computer programs (e.g., code that constitutes processor firmware, a protocol stack, a database management system, an operating system, or a combination of one or more of them).

A computer program, which can also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document, in a single file dedicated to the program in question, or in multiple coordinated files (e.g., files that store one or more modules, sub-programs, or portions of code)). A computer program can be deployed so that the program is executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry (e.g., an FPGA (field programmable gate array) or an ASIC (application-specific integrated circuit)).

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data (e.g., magnetic, magneto-optical disks, or optical disks), however, a computer need not have such devices. Moreover, a computer can be embedded in another device (e.g., a mobile telephone, a personal digital assistant (PDA), a mobile audio or video player, a game console, a Global Positioning System (GPS) receiver, or a portable storage device (e.g., a universal serial bus (USB) flash drive), to name just a few).

Computer-readable media suitable for storing computer program instructions and data include all forms of non-volatile memory on media and memory devices, including by way of example semiconductor memory devices (e.g., EPROM, EEPROM, and flash memory devices), magnetic disks (e.g., internal hard disks or removable disks), magneto-optical disks, and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback) and input from the user can be received in any form, including acoustic, speech, or tactile input. In addition, a computer can interact with a user by sending documents to and receiving documents from a device that is used by the user, for example, by sending web pages to a web browser on a user's device in response to requests received from the web browser.

Embodiments of the subject matter described in this specification can be implemented in a computing system that includes a back-end component (e.g., as a data server), or that includes a middleware component (e.g., an application server), or that includes a front-end component (e.g., a client computer having a graphical user interface or a web browser through which a user can interact with an implementation of the subject matter described in this specification), or any combination of one or more such back-end, middleware, or front-end components. The components of the system can be interconnected by any form or medium of digital data communication (e.g., a communication network). Examples of communication networks include a local area network (LAN) and a wide area network (WAN) (e.g., the Internet).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a user device (e.g., for purposes of displaying data to and receiving user input from a user interacting with the user device), which acts as a client. Data generated at the user device (e.g., a result of the user interaction) can be received from the user device at the server.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method comprising,
providing a code insert configured to integrate with an application and connect to a remote service, separate from the application to:
enable the selling and delivering of professional services, consulting, training and technical support;
enable a user to request a session with a consultant for the application from within the application,
connect the user to the consultant, and
track the duration of the session; and
charging the user for the session based on the duration.

2. The method of claim 1, further comprising:
receiving the request for the session;
identifying a consultant based in part on the application and a requested time;

3. The method of claim 2, wherein the requested time is the current time.

4. The method of claim 2, wherein the consultant is identified from a pool of available consultants that have been approved by a software partner that provides the application.

5. The method of claim 4, wherein the consultants are added to the pool of available consultants based on the consultant indicating their availability.

6. The method of claim 2, wherein connecting the user to the consultant includes establishing a network connection between the user and the consultant, the network connection configured to enable audio/video communication.

7. The method of claim 1, wherein the application is hosted by a software partner and accessed by the user using a thin client.

8. The method of claim 1, wherein the code insert is provided using a scripting language capable of being executing using a web browser.

9. A non-transitory computer storage medium encoded with computer program instructions that when executed by one or more computers cause the one or more computers to perform operations comprising:
providing a code insert configured to integrate with an application and connect to a remote service, separate from the application to:
enable the selling and delivering of professional services, consulting, training and technical support;
enable a user to request a session with a consultant for the application from within the application,
connect the user to the consultant, and
track the duration of the session; and
charging the user for the session based on the duration.

10. The system of claim 9, further comprising:
receiving the request for the session;
identifying a consultant based in part on the application and a requested time;

11. The medium of claim 10, wherein the requested time is the current time.

12. The medium of claim 10, wherein the consultant is identified from a pool of available consultants that have been approved by a software partner that provides the application.

13. The medium of claim 12, wherein the consultants are added to the pool of available consultants based on the consultant indicating their availability.

14. The medium of claim 10, wherein connecting the user to the consultant includes establishing a network connection between the user and the consultant, the network connection configured to enable audio/video communication.

15. The medium of claim 9, wherein the application is hosted by a software partner and accessed by the user using a thin client.

16. The medium of claim 9, wherein the code insert is provided using a scripting language capable of being executing using a web browser.

17. A system comprising:
one or more computers and one or more storage devices storing instructions that are operable, when executed by the one or more computers, to cause the one or more computers to perform operations comprising:
providing a code insert configured to integrate with an application and connect to a remote service, separate from the application to:
enable the selling and delivering of professional services, consulting, training and technical support;
enable a user to request a session with a consultant for the application from within the application,
connect the user to the consultant, and
track the duration of the session; and
charging the user for the session based on the duration.

18. The system of claim 17, further comprising:
receiving the request for the session;
identifying a consultant based in part on the application and a requested time;

19. The system of claim 18, wherein the requested time is the current time.

20. The system of claim 18, wherein the consultant is identified from a pool of available consultants that have been approved by a software partner that provides the application.

21. The system of claim 20, wherein the consultants are added to the pool of available consultants based on the consultant indicating their availability.

22. The system of claim 18, wherein connecting the user to the consultant includes establishing a network connection between the user and the consultant, the network connection configured to enable audio/video communication.

23. The system of claim 17, wherein the application is hosted by a software partner and accessed by the user using a thin client.

24. The system of claim 17, wherein the code insert is provided using a scripting language capable of being executing using a web browser.
